(19) United States
(12) Patent Application Publication
(10) Pub. No.: US 2006/0196230 A1
(43) Pub. Date: Sep. 7, 2006

(54) Plasma apparatus and apparatus for fabricating optical fiber preform by using the same

(75) Inventors: Se Ho Park, Gumi-si (KR); Jin-Haing Kim, Seoul (KR); Jin-Han Kim, Gumi-si (KR); Mun-Hyun Do, Chilgok-gun (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/244,664

(22) Filed: Oct. 6, 2005

(30) Foreign Application Priority Data
Mar. 7, 2005 (KR) 2005-18649

(51) Int. Cl. C03B 37/018

(52) U.S. Cl. 65/391; 65/531

(57) ABSTRACT

A plasma apparatus is disclosed. The plasma apparatus includes an internal electrode having a hollow section for receiving precursor gas and oxygen gas therein, an external electrode accommodating the internal electrode therein while forming a gap therebetween in such a manner that inert gas and oxygen gas are introduced into the gap. The plasma apparatus also includes a power source for applying a DC voltage or a radio frequency (RF) AC voltage to the internal and external electrodes in order to generate plasma between the internal and external electrodes.

### CLAIM OF PRIORITY

This application claims the benefit under 35 U.S.C. 119(a) of an application entitled “Plasma Apparatus and Apparatus For Fabricating Optical Fiber Preform By Using The Same,” filed with the Korean Intellectual Property Office on Mar. 7, 2005 and assigned Serial No. 2005-18649, the entire contents of which are incorporated herein by reference.

### BACKGROUND OF THE INVENTION

1. Field of the Invention

The present invention relates to an apparatus for fabricating an optical fiber preform. More particularly, the present invention relates to an apparatus for fabricating an optical fiber preform by using an external vapor deposition process.

2. Description of the Related Art

In general, an optical fiber may be drawn from an optical fiber preform fabricated through an external vapor deposition process. According to the conventional external vapor deposition process, soot is formed by oxidizing precursor gas using flame generated from a heating source and is deposited on a perform. This then forms the optical fiber preform.

The heating source may include a plasma heating source. There are two classifications of vapor deposition processes. The first is an internal vapor deposition process in which soot is deposited on an inner portion of a quartz tube. The second is an external vapor deposition process in which soot is deposited around a preform rod. The quartz tube and the preform rod are used as optical fiber preforms.

According to the internal vapor deposition process, soot is created in the quartz tube when a vapor-phase precursor material is oxidized due to inductively coupled plasma. The soot is deposited on the inner portion of the quartz tube due to the thermophoresis effect caused by the temperature gradient of plasma. In addition, according to the external vapor deposition process, soot is created when a vapor-phase precursor material is oxidized due to inductively coupled plasma or spark plasma. The soot is deposited around a preform rod while flowing along a plasma jet.

The precursor material used as a source gas includes SiCl₄, and the soot refers to SiO₂, which is obtained when the precursor material introduced together with oxygen (O₂) is oxidized by means of plasma.

FIG. 1 illustrates a conventional apparatus for fabricating an optical fiber preform according to the external vapor deposition process. A preform rod 110 used for fabricating the optical fiber preform is rotatably fixed by means of a chuck. A plasma apparatus 120 is aligned perpendicularly to the preform rod 110 so that the plasma apparatus 120 can move lengthwise along the preform rod 110 in order to spray flame and soot around the preform rod 110 by oxidizing source gas.

FIG. 2 further illustrates the structure of the plasma apparatus 120 shown in FIG. 1. The plasma apparatus 120 moves lengthwise along the preform rod 110, which is a preform, so as to spray flame and oxidized soot around the preform rod 110. In addition, the plasma apparatus 120 includes a cylindrical plasma tube 121 having a hollow section for receiving precursor gas, oxygen gas or inert gas and a spiral coil 122 wound around the plasma tube 121 so as to generate plasma in the plasma tube 121 when a radio frequency (RF) AC voltage is applied to both ends of the spiral coil 122.

As the RF AC voltage is applied to both ends of the spiral coil 122, plasma is created in the plasma tube 121 caused by inductively coupled heating. In this state, a mixed source gas including inert gas, oxygen gas and precursor gas is introduced into the plasma tube 121. At this time, the precursor gas is heated in the plasma tube 121 by means of the plasma and is oxidized into soot (SiO₂) by means of the oxygen gas.

The soot is sprayed onto the preform rod 110 while flowing along the plasma jet so that the soot is deposited around the preform rod 110.

However, the above-mentioned conventional plasma apparatus may cause a thermophoresis effect due to a temperature difference between a center portion and an inner wall portion of the plasma tube. This results in the oxidized soot to be deposited on the inner wall of the plasma tube. Such an oxidized soot deposited on the inner wall of the plasma tube may abrade an exhaust port of the plasma tube and interrupt the flow of the source gas introduced into the plasma tube.

### SUMMARY OF THE INVENTION

One aspect of the present invention relates to a plasma apparatus and an apparatus for fabricating an optical fiber preform by using the same, capable of improving deposition efficiency of soot and preventing the soot from being deposited onto an inner portion of the plasma apparatus.

One embodiment of the present invention is directed to a plasma apparatus including electrodes aligned in a dual tube structure while forming a predetermined gap therebetween in order to generate plasma when a radio frequency (RF) AC voltage is applied thereto; and a power source for applying the RF AC voltage to the electrodes.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a drawing illustrating a conventional apparatus for fabricating an optical fiber preform according to an external vapor deposition process;

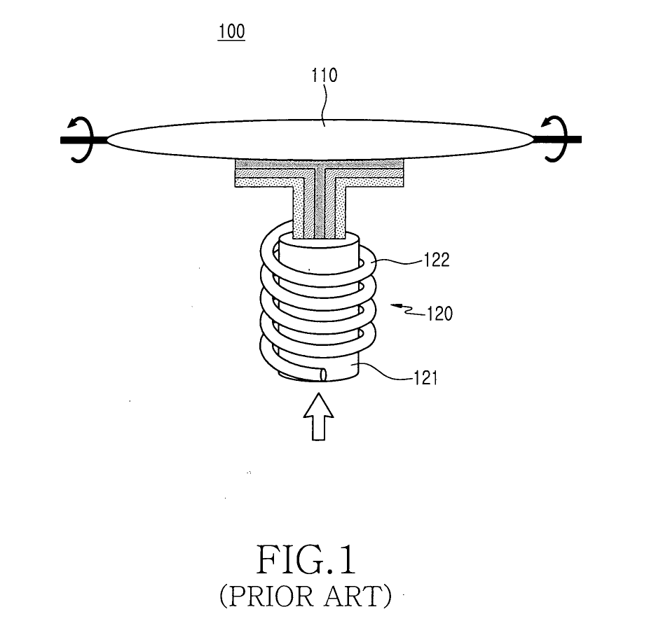

FIG. 2 is a schematic drawing which further illustrates the structure of the plasma apparatus shown in FIG. 1;

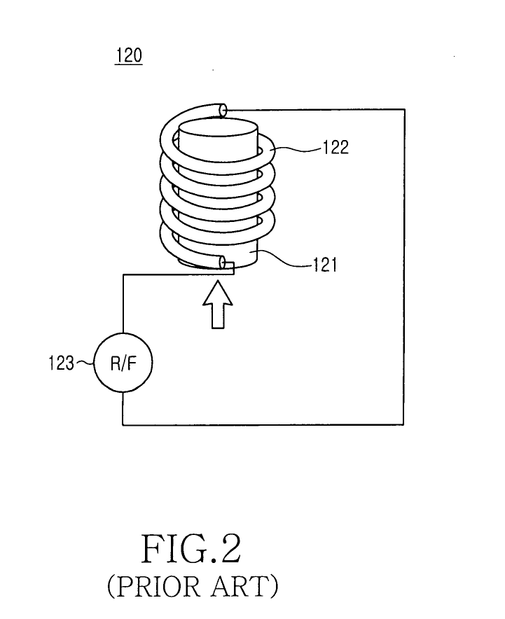

FIG. 3 is a schematic view illustrating a structure of a plasma apparatus according to a first embodiment of the present invention;

FIG. 4 is a perspective view illustrating an apparatus for fabricating an optical fiber preform equipped with a plasma apparatus according to a second embodiment of the present invention; and

FIGS. 5 and 6 are graphs for showing characteristics of a plasma apparatus shown in FIG. 3.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may obscure the subject matter of the present invention.

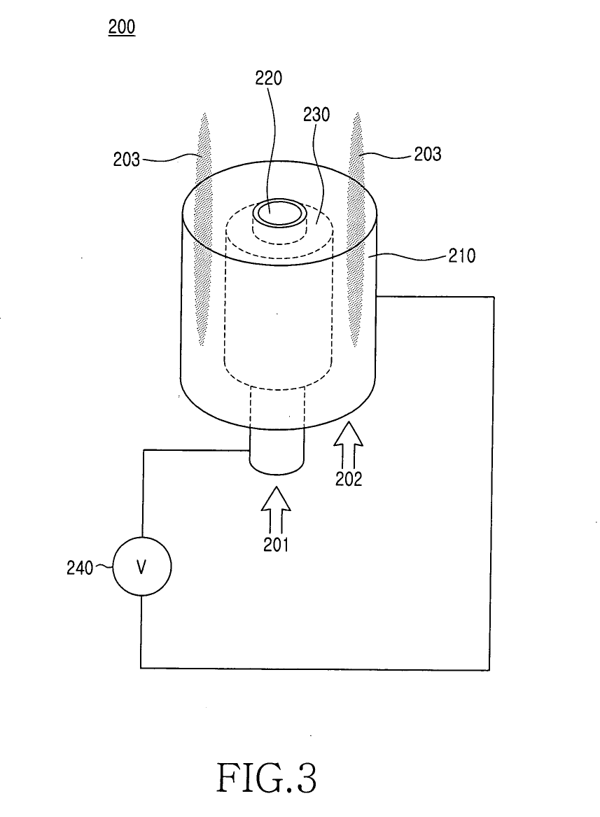

FIG. 3 is a schematic view illustrating a structure of a plasma apparatus 200 according to a first embodiment of the present invention. The plasma apparatus 200 includes an internal electrode 220 having a hollow section for receiving precursor gas and oxygen gas 201, and an external electrode 210 accommodating the internal electrode 220 therein while forming a gap therebetween such that inert gas and oxygen gas 220 is introduced into the gap. The plasma apparatus 200 also includes a power source 240 for applying an RF AC voltage to the external electrode 210 and the internal electrode 220 in order to generate plasma 203 therebetween, and a dielectric tube 230 interposed between the external electrode 210 and the internal electrode 220.

The internal electrode 220 is a hollow and may have a cylindrical tube shape. The precursor gas and the oxygen gas 201 including SiCl₄, GeCl₄ or a mixture thereof are introduced into the hollow cylindrical tube.

The external electrode 210 is a hollow and may also have a cylindrical tube in which the internal electrode 220 is accommodated while forming the predetermined gap therebetween. In this embodiment, the external and internal electrodes 210 and 220 are made from a metal material that has superior electric conductivity. Openings formed at both ends of the external and internal electrodes 210 and 220 are directed in the same direction.

In addition, the inert gas introduced into the gap formed between the external and internal electrodes 210 and 220 may include He, Ar, Kr, N2 or a mixture thereof.

The dielectric tube 230 may have a cylindrical structure, and the dielectric tube 230 is aligned between the external and internal electrodes 210 and 220. The dielectric tube 230 reduces a voltage causing discharge and ionization of gas, thereby activating the plasma.

The power source 240 is electrically connected to the external and internal electrodes 210 and 220 in order to apply power to the external and internal electrodes 210 and 220 for generating the plasma. As the power is applied to the external and internal electrodes 210 and 220, the plasma is generated between the external and internal electrodes 210 and 220 due to discharge and ionization of gas. If RF power is applied to the external and internal electrodes 210 and 220, the plasma activation can be increased.

In this embodiment, since the plasma apparatus 200 includes the external and internal electrodes 210 and 220 having the hollow cylindrical structures, a hollow plasma jet can be applied onto a preform rod 310. The plasma generated between the external and internal electrodes 210 and 220 may apply heat to the precursor gas and oxygen gas introduced into the internal electrode 220, thereby oxidizing the precursor gas into the soot.

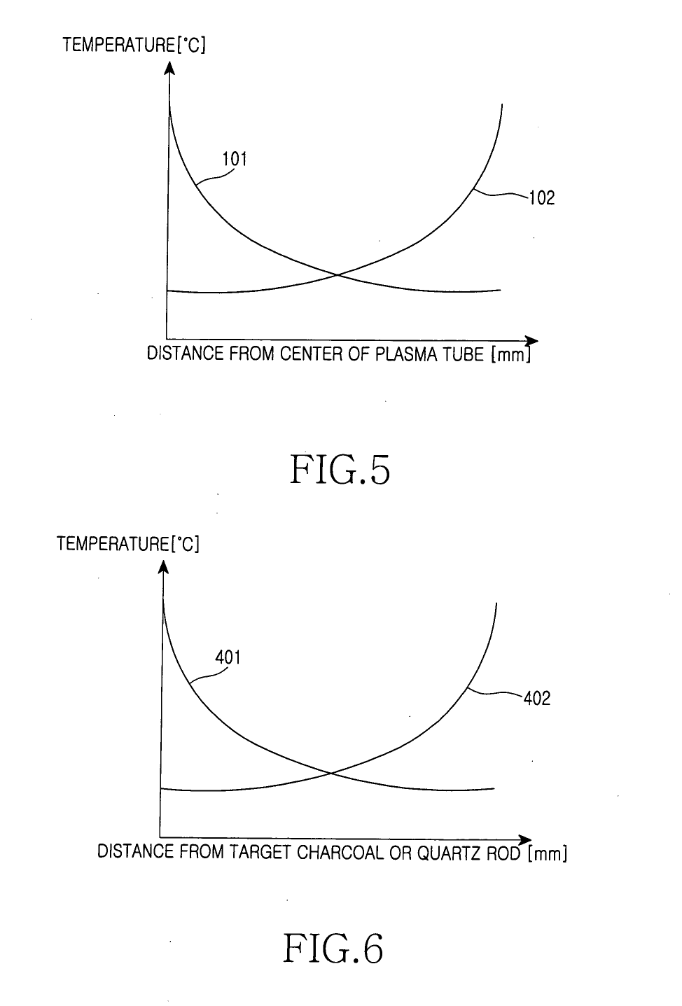

FIGS. 5 and 6 are graphs for showing temperature characteristics of the plasma apparatus 200 shown in FIG. 3. The graphs illustrate a temperature distribution between an inner portion of the internal electrode 220 and an inner wall of the external electrode 210 of the plasma apparatus 200. Referring to FIG. 5, since the temperature at the center of the plasma apparatus 200 is lower than the temperature at the outer peripheral portion of the plasma apparatus, the soot is prevented from depositing onto the inner wall of the plasma device caused by the thermophoresis effect. Referring to FIG. 6, the temperature of a plasma jet radiated from the plasma may decrease as it reaches the preform rod 310. The temperature of the plasma jet radiated from the plasma may increase as it is far from the preform rod 310. Accordingly, the soot is deposited around the preform rod 310 due to the effect. That is, FIG. 5 is a graph for comparing a curve (102) representing a temperature characteristic that the temperature increases as it distances away from the center of a plasma tube according to the present invention, and a curve (101) represents a temperature characteristic that the temperature decreases as the distance becomes far away from the center of a plasma according to a conventional art. FIG. 6 is a graph for comparing a curve (402) representing a temperature characteristic of temperature increases as it distances away from a target charcoal, and a curve (401) represents a temperature characteristic that the temperature decrease as the distance becomes far from the target charcoal.

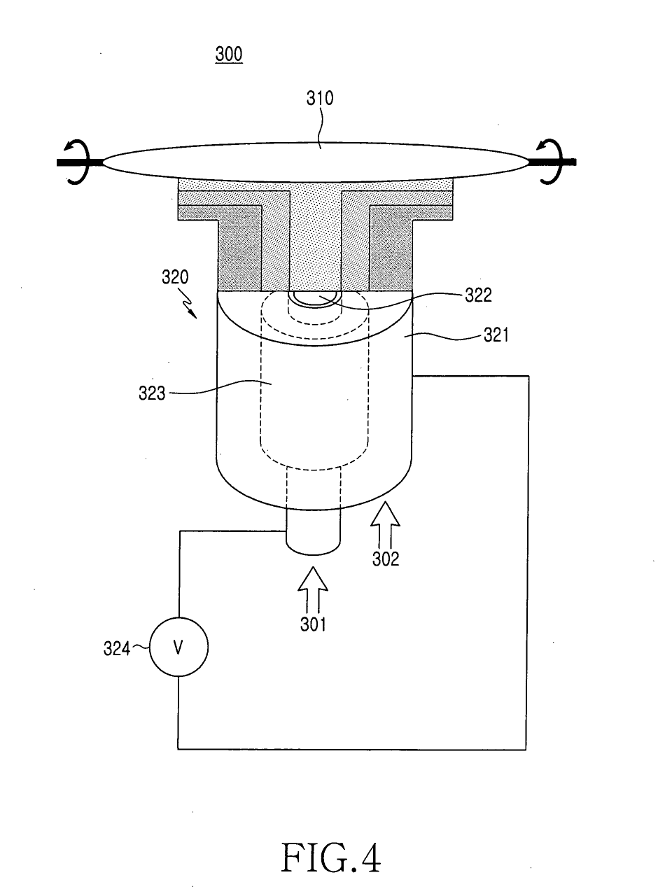

FIG. 4 is a perspective view illustrating an apparatus 300 for fabricating an optical fiber preform equipped with a plasma apparatus according to a second embodiment of the present invention. As shown, the apparatus 300 includes a preform rod 310 both ends of which are rotatably supported by a pair of chucks, and a plasma apparatus 320 having a dual tube structure including tubes aligned while forming a predetermined gap therebetween. As an RF AC voltage is applied to the plasma apparatus 320, the plasma apparatus 320 oxidizes precursor gas into soot by using plasma and oxygen gas and deposits the soot around the preform rod 310. The apparatus 300 includes the chucks (not shown) for rotatably supporting the preform rod 310 on a lathe (not shown), and the plasma apparatus 320 is movably installed on the lathe.

The plasma apparatus 320 includes an internal electrode 322, an external electrode 321, a dielectric tube 323 and a power source 324.

Precursor gas and oxygen gas 321 are introduced into the internal electrode 322 and inert gas and oxygen gas 302 are introduced between the external electrode 321 and the internal electrode 322. The power source 324 applies a voltage to the external electrode 321 and the internal electrode 322 so that plasma is generated between the external electrode 321 and the internal electrode 322. The precursor gas introduced into the internal electrode 322 is heated by means of the plasma. The heated precursor gas reacts with the oxygen gas, so that the precursor gas is oxidized into the soot.

Since the plasma apparatus 320 generates the plasma between the external electrode 321 and the internal electrode 322, a thermal cavity is formed at a center portion of the plasma jet radiated onto the preform rod 310. The temperature of the plasma jet radiated onto the preform rod 310 may gradually increase from the center portion to the peripheral portion of the plasma jet. Therefore, heat directly applied to the preform rod has a temperature relatively lower than the temperature of the peripheral portion of the plasma jet, which improves the thermophoresis effect. The soot is deposited around the preform rod 310 while flowing along the plasma jet radiated from the plasma apparatus 320.

The plasma apparatuses described above have a dual tube structure, in which source gas including the precursor gas is introduced into the internal tube of the plasma apparatus. Accordingly, the internal temperature of the plasma apparatus is significantly lower than the temperature of the plasma, so that the soot is deposited around the preform in a solid state before it is completely vitrificated. Thus, gas can be easily removed from the deposited soot after the deposition process has been completed and a dehydration process can be carried out.

In addition, since the internal temperature of the plasma apparatus is lower than the temperature of the plasma, vaporization of Ge oxide and the defect in the mesh structure of quartz glass is prevented or reduced. As a result, the defect in the mesh structure of the preform is reduced and the hydrogen bond is restricted, thereby reducing penetration loss caused by the hydrogen bond. Furthermore, since low-temperature gas including quartz glass particles is grown from the preform while being surrounded by the high-temperature plasma, the deposition efficiency of the particles is improved due to the thermophoresis effect.

While the invention has been shown and described with reference to certain embodiments thereof, it will be understood by those skilled in the art that various changes in form and details may be made therein without departing from the spirit and scope of the invention as defined by the appended claims.

What is claimed is:

1. A plasma apparatus comprising:
a plurality of electrodes aligned to form a gap therebetween in order to generate plasma when a radio frequency (RF) AC voltage is applied thereto; and
a power source for applying the RF AC voltage to the plurality of electrodes.

2. The plasma apparatus as claimed in claim 1, wherein the plurality of electrodes includes a cylindrical tube structure.

3. A plasma apparatus comprising:
a first electrode having a hollow section for receiving precursor gas and oxygen gas;
a second electrode accommodating the first electrode therein while forming a gap therebetween so that inert gas and oxygen gas can be introduced into the gap; and
a power source for applying a radio frequency (RF) AC voltage to the first and second electrodes in order to generate plasma.

4. The plasma apparatus as claimed in claim 3, further comprising a dielectric tube installed between the first and second electrodes.

5. The plasma apparatus as claimed in claim 3, wherein the precursor gas includes SiCl₄, GeCl₄ or a mixture thereof.

6. The plasma apparatus as claimed in claim 3, wherein the inert gas includes He, Ar, Kr, N₂, or a mixture thereof.

7. An apparatus for fabricating an optical fiber preform using an external vapor deposition process, the apparatus comprising:
a plurality of chucks
a based rod both ends of which are rotatably supported by the plurality of chucks; and
a plasma apparatus including a plurality of electrodes aligned to form a gap therebetween, wherein the plasma apparatus oxidizes precursor gas into soot by using plasma and oxygen gas and deposits the soot around the preform rod as a radio frequency (RF) AC voltage is applied thereto.

8. The apparatus as claimed in claim 7, wherein the plasma apparatus includes an internal electrode having a hollow section for receiving precursor gas and oxygen gas therein, an external electrode accommodating the internal electrode therein while forming a gap therebetween in such a manner that inert gas and oxygen gas are introduced into the gap, and a power source for applying the RF AC voltage to the internal and external electrodes in order to generate plasma between the internal and external electrodes.

9. The apparatus as claimed in claim 8, further comprising a dielectric tube installed between the internal and external electrodes.

10. The apparatus as claimed in claim 7, wherein a temperature of the plasma applied to the preform rod is increased as a distance between the plasma and the preform rod becomes more distant.

11. A method for fabricating an optical fiber preform, the method comprising the steps of:
supporting a preform rod;
inserting a precursor gas and oxygen gas between an internal and external electrode, wherein the external electrode accommodates the internal electrode to form a gap therebetween;
applying a RF AC voltage to the internal and external electrodes in order to generate plasma between the internal and external electrodes; and
oxidizing the precursor gas into soot using the plasma and oxygen gas to deposits soot around the preform rod.

12. The method as claimed in claim 11, further comprising the step of changing the position of the prefrom rod, relative to the soot, to deposit the soot on different portions of the perform rod.
